(19) United States
(12) Patent Application Publication
(10) Pub. No.: US 2025/0121340 A1
(43) Pub. Date: Apr. 17, 2025

(54) Methane pyrolysis in a supersaturated molten mixture of metal and carbon

(71) Applicant: Molten Industries Inc., Oakland, CA (US)

(72) Inventors: Kevin A. Bush, Oakland, CA (US); Caleb C. Boyd, San Francisco, CA (US); Benjamin M. Rush, Oakland, CA (US)

(21) Appl. No.: 18/915,926

(22) Filed: Oct. 15, 2024

Related U.S. Application Data
(60) Provisional application No. 63/544,415, filed on Oct. 16, 2023.

(51) Int. Cl. B01J 6/00; C01B 3/24; C01B 32/205

(52) U.S. Cl. CPC B01J 6/008; C01B 3/24; C01B 32/205; C01B 2203/0266; C01B 2203/049; C01B 2203/1241; C01P 2002/72; C01P 2002/82; C01P 2006/40

(57) ABSTRACT

A decomposition reactor equipped with a thermochemical decomposition reactor for performing a thermochemical decomposition of a hydrocarbon feedstock such as methane or natural gas, as well as a method for performing the thermochemical decomposition and process for obtaining a carbon product therefrom. The thermochemical decomposition reactor holds a supersaturated molten mixture primarily of a metal and carbon, where the metal is Mn, Fe, Co and Ni or an alloy comprising more than 50% of the metal. A heater heats and maintains supersaturated molten mixture in supersaturation with carbon while the hydrocarbon feedstock is injected to pass through the supersaturated molten mixture and be pyrolyzed to yield pyrolysis products that primarily include hydrogen and the desired carbon product. A hydrogen extraction means extracts the hydrogen and carbon product and a carbon separation means separates the carbon product preferably including a solid carbon product that is highly graphitic.

### CROSS-REFERENCE TO RELATED APPLICATIONS

This application claims priority from U.S. Provisional Patent Application No. 63/544,415 filed on Oct. 16, 2023 and which is incorporated herein by reference for all purposes in its entirety.

### FIELD OF THE INVENTION

The present invention relates to performing methane pyrolysis in a molten mixture of metal that is supersaturated with carbon, hence supersaturated molten mixture, and more specifically to appropriate selection of suitable metal for the supersaturated molten mixture and conditions for methane pyrolysis carried out therein to obtain hydrogen and highly graphitic carbon.

### BACKGROUND OF THE INVENTION

The United States produces 10 million metric tons of hydrogen per year. 95% of it is produced via steam methane reforming (SMR) and is accompanied by the emission of 100 million tons of CO₂ in the process, as documented by A. Majumdar et al., “A framework for a hydrogen economy”, Joule, Vol. 4, Issue 8, 18 Aug. 2021, pp. 1905-1908.

Methane pyrolysis, also known as methane cracking or methane splitting, involves the thermochemical decomposition of a hydrocarbon feedstock primarily composed of methane (CH₄) into its constituent elements, namely hydrogen (H₂) and solid carbon. Note that other products of the hydrocarbon decomposition process may be formed such as ethane, ethylene, acetylene and benzene. The pyrolysis process is typically conducted at elevated temperatures, typically above 1,000° C., in the absence of oxygen to avoid the formation of gaseous carbon dioxide (CO₂) and carbon monoxide (CO). Furthermore, the pyrolysis process is endothermic and requires a substantial input of heat energy to break the carbon-hydrogen bonds in methane.

Methane pyrolysis is potentially the most cost-effective solution to reduce emissions associated with hydrogen production. Unfortunately, the existing approaches have proved difficult to scale. Scaling issues have been documented by M. Steinberg, “The direct use of natural gas for conversion of carbonaceous raw materials to fuels and chemical feedstocks”, International Journal of Hydrogen Energy, Vol. 11, Issue 11, 1986, pp. 715-720 and also by S. Schneider et al., “State of the Art of Hydrogen Production via Pyrolysis of Natural Gas, ChemBioEng Reviews, Vol. 7, 2020, pp. 1-10. Still, obtaining hydrogen via methane decomposition holds the promise of being less expensive than producing it through water electrolysis or through existing steam methane reforming with carbon capture.

Thermal decomposition of a hydrocarbon feedstock such as methane can be performed with or without the presence of an active catalyst. In the absence of a catalyst, temperatures for thermal decomposition of methane into hydrogen and solid carbon are typically above 1,000° C. Catalytic materials can reduce the temperature of thermal decomposition to as low as 400° C. or even lower. Catalytic materials for the decomposition of hydrocarbons include but are not limited to Group VIb and VIII elements of the periodic table such as iron (Fe), nickel (Ni), cobalt (Co), noble metals, chromium (Cr), molybdenum (Mb), alloys of these metals and even salts and oxides containing these metals.

With or without catalysts, scalable, cost-effective methane pyrolysis has yet to be widely commercialized as it presents a number of fundamental process design and scale-up challenges. The high temperature requirements constrain the choice of construction materials and require efficient heat transfer at high throughputs. The process generates both gaseous hydrogen and solid carbon, which must be physically separated. In fact, deposition of solid carbon in the reactor or coking is a major operational problem for thermal decomposition of any hydrocarbon feedstock. Further, the process requires frequent reactor cleaning. This results in downtime and non-continuous operation. Catalysts are deactivated by solid carbon deposition and must be replaced or cleaned. Catalytic metals and salts can contaminate the solid carbon byproduct such that it cannot be used in all applications. Indeed, in some cases the extent of contamination is so high that the solid carbon byproduct must even be disposed of as toxic waste.

Typical approaches to hydrocarbon decomposition include moving bed and fluidized bed reactors, plasma reactors, microwave reactors, molten bath reactors and fluid wall reactors. The primary challenge in the operation of a continuous or semi-continuous methane pyrolysis process lies in overcoming reactor fouling caused by the formation of solid carbon. Solid carbon can coat reactor surfaces. This is especially true in cases where the thermal decomposition occurs at a surface and leads to the formation of a hard carbon deposit thereon. The deposit can build up to the point where it could clog the reactor and thus force a shutdown and cleaning.

Plasma, microwave and fluidized bed reactors typically attempt to overcome the carbon fouling issue by ensuring that energy or heat is transferred to the methane away from the walls of the reactor, thus forming a carbon product that can be fluidized out of the reactor. The challenge with these reactors is that their walls typically need to be cooled to avoid carbon deposition on them, thus lowering the energy efficiency of the reactor. It would be preferable from an energy efficiency perspective to operate an isothermal reactor where the pyrolysis reaction is taking place so that energy is not lost to the surrounding environment or else lost in active cooling.

Molten salt and molten metal reactors aim to overcome that same challenge by transferring heat to the hydrocarbon or methane gas through contact with molten media. The molten media serves a dual purpose. It acts as a heat transfer medium and it also serves to minimize the interaction of the gas with the walls of the reactor to avoid carbon deposition thereon. A molten material is typically chosen such that the density of the carbon formed is less than the density of the molten material. This causes the carbon formed during hydrocarbon pyrolysis to float to the top of the molten material where it can be extracted and separated from the reactor. Combined, the benefits of high energy efficiency, minimal reactor fouling and continuous carbon extraction demonstrate the strong promise of molten media hydrocarbon pyrolysis for the formation of hydrogen and solid carbon without gaseous carbon dioxide emissions.

Although molten media hydrocarbon pyrolysis was first patented by Auguste Jean Paris Jr. in 1915 in U.S. Pat. Nos. 1,756,877 and 1,392,788 the process and corresponding reactors have failed to reach commercial traction and viability. There are a number of factors that have led to the challenges in industrial scale commercialization of this approach. Among these factors we find: (1) poor reaction yield, (2) formation of CO or CO₂ and (3) contamination of the solid carbon product that is formed with the molten material being used.

Poor reaction yield is typically the result of insufficient residence time of the hydrocarbon gas at high temperature or temperatures too low to achieve high pyrolysis yield to hydrogen and carbon. This problem has plagued molten salt reactors. They struggle to operate at temperatures above 1,100° C. as the vapor pressure of the typically used molten salts becomes too high. At pyrolysis temperatures below 1,100° C. a residence time of more than 1 second is necessary to get yields of over 80%. Yield is defined herein as the ratio of hydrogen produced to the total amount of hydrogen that could be produced stoichiometrically from complete pyrolysis of methane.

The formation of gaseous CO or CO₂ is the result of the usage of oxidizing agents to break down the carbon created. This is clearly not desirable when the goal is to create hydrogen without CO₂ emissions.

Finally, contamination is an issue when even a few weight % of molten material is found in the solid carbon. The reactor and hydrogen product economics are negatively affected as the molten materials typically used are expensive. Their expense is greatly compounded if they cannot be easily recovered. For example, if liquid tin is used as the molten material for pyrolysis and if the carbon produced from the methane pyrolysis process contains 1 mass % tin and the cost of tin is $32/kg, then the cost of the tin lost is equivalent to $0.95/kg of H₂ produced. This illustrates how even a small amount of metal contamination in the solid carbon can have a significant impact on the resulting cost of the hydrogen produced, especially if the goal is to sell clean hydrogen at less than $2/kg H₂.

The prior art focused on methane pyrolysis in molten media has specifically avoided the formation of molten metal carbides and miscible molten mixtures. This avoidance of molten metal carbides is advocated by the prior art in several ways. First, by using molten metals which do not form carbides and are immiscible with carbon. These include lead (Pb), tin (Sn), gallium (Ga), bismuth (Bi) or indium (In). Second, by using metals which do form a carbide but then decomposing the carbide. Third, by using molten salts. Fourth, by oxidizing dissolved carbon in a gasification process. Examples of these cases are described below.

The conventional wisdom in the art, dating back to U.S. Pat. Nos. 1,756,877 and 1,392,788 to Auguste Jean Paris Jr., teaches that liquid metals which do not react with carbon to form carbides are preferred for hydrocarbon pyrolysis. Paris himself teaches in U.S. Pat. No. 1,392,788 the usage of a bath of “molten mass of metal, preferably lead” so that “the bottom of the still is kept entirely free from any deposit of carbon or other residues”. Liquid metals such as Pb, Sn, Ga, Bi and In are low melting point metals. They are known to not form carbides at atmospheric pressure and thus should not react with the carbon formed during hydrocarbon pyrolysis.

Much more recently, the teachings of U.S. Pat. No. 9,156,017 to Lee et al. entitled “Pyrolysis apparatus using liquid metal” confirms that Sn and Bi are the best choice of liquid metals. Their teachings state that “the liquid metal may include any one of a group consisting of Sn, Bi, and a mixture of Sn and Bi”. Further, U.S. Pat. No. 10,851,307 to Desai et al. entitled “System and method for pyrolysis using a liquid metal catalyst” also teaches that the liquid metals are Sn, Pb and Bi, although they are “not particularly active for methane decomposition”. The Karlsruhe Institute of Technology (KIT) has published several papers on methane pyrolysis that focus on the usage of liquid Sn as their molten metal medium. For example, in their EP Pat. No. 3,521,241 they teach that “the liquid metal media can comprise, preferably, molten tin. However, other metal materials such as lead, a eutectic alloy (45/55) of lead and bismuth or a carbonate molten salt could also be used, such as NaCO₃”. More recently still, their Patent GB 2,605,797 describes the circulation of a liquid metal for pyrolysis and that, “[l]ead, or a mixture primarily containing lead, may be used as the liquid metal. Gallium is another possible choice.” Clearly, the prior art has placed a significant emphasis on the usage of liquid metals that do not form carbides.

There are also a few published patent applications that do not use conventional liquid metals (Pb, Sn, Bi, In and Ga), but instead teach the use of metals for hydrocarbon pyrolysis which form unstable carbides. These metals include copper (Cu), magnesium (Mg), silver (Ag) and nickel (Ni). U.S. Pat. No. 1,418,385 to Henry James Masson teaches that “[t]he material which is melted in the pot to form the bath should not react with carbon and the hydrogen to form a carbide or hydride which shall be stable at the high temperatures used”. This patent further specifies that metals which could be used are “magnesium, copper, silver [and] nickel”. All of these metals create carbides which are not stable at the elevated temperatures used in methane pyrolysis (>800° C.). Several drawbacks to U.S. Pat. No. 1,418,385 include teaching the creation of “lampblack, carbon black and the like” by removing the carbon with “sufficient rapidity to maintain the black color and softness of the carbon produced” thus teaching away from production of highly ordered, graphitic carbon. Furthermore, the '385 patent teaches that “to secure lampblack, it is desirable to use a temperature below 2,000° F., a temperature of about 1,500° F. being suitable”, while a nickel-carbon alloy melts at a minimum temperature of 1,318° C. or 2,404° F. Also, the '385 patent teaches forming a carbide with a catalytic substance and subsequently decomposing the formed carbide.

Due to the high cost of liquid metals, there has recently been more interest in molten salts as the liquid medium for hydrocarbon pyrolysis. Prior art in this field, again, teaches the use of molten media or material for hydrocarbon pyrolysis which does not react with the solid carbon or hydrogen produced during pyrolysis. For example, US Published Patent Applications 2021/0061654; 2020/0283293 and U.S. Pat. No. 10,882,743 discuss the use of various molten salts such as NaCl, NaBr, KCl, KBr and ZnCl₂, among others. Specifically, the '293 application focuses on the use of molten salts for the purpose of “separating contamination-free carbon from the metal surface”.

The above references show how the prior art on hydrocarbon pyrolysis in molten media has focused on avoiding the reaction of molten material with the solid carbon produced. Conversely, there are several published applications that teach the injection of a hydrocarbon feedstock into a molten material which does form a carbide, in particular molten iron (Fe), although all of these published applications focus on hydrocarbon gasification to form hydrogen, carbon monoxide, and carbon dioxide rather than solid carbon. U.S. Pat. No. 1,803,221 from 1930 teaches the dissolution of carbon into molten metal and “then burning out the carbon from said metal by means of a gas containing oxygen.” The burning of the carbon would lead to the formation of carbon dioxide, which is a greenhouse gas. Many Published Applications and Patents have built on this prior art where carbon is dissolved in a molten metal and then oxidized to remove the carbon such as: U.S. Pat. Nos. 3,729,297; 5,435,814; 6,110,239; WO 2012/141621; WO 2008/083466; U.S. Pat. Nos. 6,350,289; 4,187,672; 4,244,180; 5,537,940; 6,315,802 and 5,767,165. U.S. Pat. No. 6,350,289 specifically states that “the amount of carbon in the molten iron [ . . . ] should not normally exceed an upper limit as set by the solubility of carbon in molten iron.” All of the patent publications in the present paragraph are not performing hydrocarbon pyrolysis with the purpose of producing hydrogen and solid carbon, while avoiding the formation of gaseous CO and CO₂. Instead, these patent publications teach to oxidize the carbon dissolved in molten metal with oxygen except for U.S. Pat. No. 6,315,802 which oxidized the carbon dissolved with sulfur, specifically to remove sulfur. The purpose of oxidizing the carbon is to remove the carbon as a gas and maintain the levels of carbon in the melt below the solubility limit.

The voluminous prior art and many attempts to make methane pyrolysis in molten media more accessible and practicable have still not provided for a cost-effective and efficient manner of achieving this goal. More precisely, the prior art does not provide for overcoming the challenges facing pyrolysis of hydrocarbon feedstocks such as those consisting of methane in molten media while avoiding reactor fouling and providing for energy efficiency under continuous operation.

### Objects and Advantages

The present invention is aimed at overcoming the challenges facing current molten media methane pyrolysis reactors while achieving the benefits of high energy efficiency, minimal reactor fouling, and continuous operation.

More precisely, it is an aim of the present invention to enable pyrolysis of hydrocarbon feedstocks such as methane in earth abundant metals to overcome the cost challenges associated with typical molten metals and salts.

It is yet another objective of the present invention to enable the formation of highly graphitic carbon, which has a variety of uses including as an electrode material in electric arc furnaces, batteries, as a lubricant or as a refractory material.

### SUMMARY OF THE INVENTION

The objects and advantages of the invention are provided for by a decomposition reactor and a process for performing a thermochemical decomposition of a hydrocarbon feedstock. The decomposition reactor has within it a thermochemical decomposition reactor for holding a supersaturated molten mixture that is primarily made up of a metal and carbon. The metal is preferably selected from among Mn, Fe, Co and Ni or an alloy comprising more than 50% of the metal. Further, the decomposition reactor has a heater for heating the supersaturated molten mixture and for maintaining supersaturation of the molten mixture with carbon. The heater is typically selected from among electrical resistive heaters, induction heaters, microwave heaters, electric arc heaters, natural gas burners, hydrogen burners, plasma heaters and a thermal energy storage medium.

The decomposition reactor has a means for injecting a supply flow of the hydrocarbon feedstock into the supersaturated molten mixture while the latter is being held within the thermochemical decomposition reactor. The means for injecting the flow is typically adapted to perform the injection through a wall of the thermochemical decomposition reactor such that the supply flow enters the supersaturated molten mixture contained inside. As a result, the hydrocarbon feedstock passes through the supersaturated molten mixture and is pyrolyzed (a process also known as cracking or direct decomposition) to yield pyrolysis products that primarily include hydrogen and a carbon product.

The decomposition reactor is equipped with a hydrogen extraction means for extracting hydrogen generated by pyrolysis of the hydrocarbon feedstock. The hydrogen extraction means is configured to extract the hydrogen from the top of the supersaturated molten mixture. The decomposition reactor is also equipped with a carbon separation means for separating the carbon product obtained by pyrolyzing the hydrocarbon feedstock.

There are many candidates for use as hydrocarbon feedstock including gases, liquids and solids containing one or more hydrocarbons. Preferably, the hydrocarbon feedstock is mostly made up of methane or natural gas. More generally, however, hydrocarbons such as butane, propane, ethane, ethylene, acetylene, propylene, liquified petroleum gas, naphtha, shale oil, wood, biomass, organic waste streams, biogas, gasoline, kerosene, diesel fuel, residual oil, crude oil, carbon black oil, coal tar, crude coal tar, benzene, methyl naphthalene, polycyclic aromatic hydrocarbons and other such hydrocarbons are also suitable. In fact, mixtures containing any of the above with other hydrocarbon feedstocks can be used. Also, mixtures containing any of these feedstocks with still others such as mixtures of methane and nitrogen, methane and carbon dioxide or methane and carbon monoxide are suitable as well.

Preferably, when the hydrocarbon feedstock is substantially composed of methane or natural gas the carbon product is a solid carbon product. For example, the solid carbon product comprises a fraction of a crystalline phase of carbon defined as graphite, graphene, nanotubes, diamond and fullerenes. Specifically, it is advantageous when the solid carbon product is highly graphitic.

It is important for the heater to maintain the supersaturated molten mixture in a state of supersaturation with carbon. To that end, the heater maintains a temperature between 1,100° C. and 2,000° C. since high enough solubility of carbon in metal is achieved at such high temperatures. When supersaturated, the molten mixture of metal and carbon is in a condition above a miscibility limit. At this point any additional carbon either precipitates as a solid from the molten mixture or simply cannot be dissolved into the liquid state.

It should be noted that the use of supersaturated molten mixtures containing metals is typically avoided in the prior art. More precisely, the prior art teaches away from using metals that form carbides in methane pyrolysis. Instead, the prior art teaches using molten metals or salts that do not form carbides, and also teaches away from oxidation of any carbides or use of unstable carbides. In contrast, the present invention uses molten metal and carbon in the supersaturated molten mixture to specifically enable formation of crystalline or graphitic carbon product rather than amorphous carbon product.

In many embodiments the pyrolysis products obtained from passing the hydrocarbon feedstock through the supersaturated molten mixture comprise pyrolysis gases. Thus, it is convenient for the decomposition reactor to have a carbon separation means that is configured to fluidize the carbon product out of the decomposition reactor using the very pyrolysis gases obtained by pyrolysis.

Given the high temperature maintained by the heater the height (or depth) of the supersaturated molten mixture does not need to be large. In fact, in many embodiments the height of the supersaturated molten mixture into which the supply flow of the hydrocarbon feedstock is injected need only be greater than 2 cm and up to 15 cm. Of course, heights in excess of 15 cm can also be used when near complete pyrolysis is desired.

The invention also covers a process for achieving thermochemical decomposition (cracking or direct decomposition) of a hydrocarbon feedstock. The process involves providing a thermochemical decomposition reactor, which may be held within a decomposition reactor. The thermochemical decomposition reactor is designed for holding a molten metal bath that primarily comprises a metal and carbon.

The process deploys a heater for heating the molten metal bath to obtain a supersaturated molten mixture, i.e., a molten mixture that is supersaturated with carbon. Furthermore, the heater maintains the supersaturation at a temperature between 1,100° C. and 2,000° C.

Further, the process calls for injecting a supply flow of the hydrocarbon feedstock into the supersaturated molten mixture held in the thermochemical decomposition reactor. The step of injecting is performed such that the hydrocarbon feedstock passes through the supersaturated molten mixture to pyrolyze the hydrocarbon feedstock. Thus, for example, injecting of the hydrocarbon feedstock is performed through a plurality of orifices.

The pyrolysis products obtained comprise primarily hydrogen and a carbon product. Moreover, the pyrolysis products are in the form of pyrolysis gases. Still further, the process calls for extracting the hydrogen from the top of the supersaturated molten mixture and also for separating the carbon product.

The process of the invention preferably uses a metal selected from among Mn, Fe, Co and Ni or an alloy of such metal. In fact, it is preferable that the metal or alloy consist primarily of these, meaning that it contains >50% Mn, Fe, Co or Ni.

The hydrocarbon feedstock is preferably made up of methane or natural gas and the carbon product is preferably a solid carbon product, and more specifically a solid carbon product composed of a fraction of a crystalline phase of carbon defined as graphite, graphene, nanotubes, diamond and fullerenes. When the solid carbon product is highly graphitic it has many advantageous uses, including in electrodes for batteries, electric arc furnaces or supercapacitors.

It is further preferred that the step of separating of the carbon product use the pyrolysis gases produced during pyrolysis of the hydrocarbon feedstock. Specifically, the step of separating involves at least partial and more preferably full fluidization of the carbon product out of the thermochemical decomposition reactor by the pyrolysis gases.

The height (depth) of the supersaturated molten mixture can vary, but is typically shallow. For example, the height of the supersaturated molten mixture into which the supply flow of the hydrocarbon feedstock is injected is greater than 2 cm or even greater than 15 cm. The height (depth) chosen in the process will depend on the desired degree of pyrolysis.

The process can deploy various types of heaters, including the previously mentioned electrical resistive heaters, induction heaters, microwave heaters, plasma heaters and also a thermal energy storage medium.

Furthermore, the invention also extends to a process for obtaining a carbon product in a process of thermochemical decomposition of the hydrocarbon feedstock. Specifically, the carbon product obtained through the process is solid and preferably highly graphitic.

The present invention, including the preferred embodiment, will now be described in detail in the below detailed description with reference to the attached drawing figures.

### BRIEF DESCRIPTION OF THE DRAWING FIGURES

FIG. 1A is a perspective schematic diagram of the main elements of a decomposition reactor with a thermochemical decomposition reactor for performing hydrocarbon feedstock pyrolysis in a supersaturated molten mixture according to the invention

FIG. 1B is an isometric schematic diagram showing the decomposition reactor of FIG. 1A in conjunction with a number of additional elements

FIG. 2 is a flow diagram that explains the operation of the decomposition reactor illustrated in FIGS. 1A-B

FIG. 3 is a phase diagram for nickel and carbon (Ni—C) indicating the proper region for operating in accordance with the invention

FIG. 4 is a phase diagram for manganese and carbon (Mn—C) indicating the proper region for operating in accordance with the invention

FIG. 5 is a phase diagram for iron and carbon (Fe—C) indicating the proper region for operating in accordance with the invention

FIG. 6 is a phase diagram for cobalt and carbon (Co—C) indicating the proper region for operating in accordance with the invention

FIG. 7 is a phase diagram for copper and carbon (Cu—C) indicating the proper region for operating in accordance with the invention

FIG. 8 is an x-ray diffraction (XRD) plot evidencing the production of graphite during the pyrolysis reaction according to the invention

FIG. 9 is a Raman spectroscopy spectrum further characterizing the exact crystalline phases of the solid carbon produced according to the invention

FIG. 10 is an image of a carbon product obtained in pyrolysis in supersaturated molten mixture according to the invention

FIG. 11 illustrates Raman spectra of graphene, carbon nanotubes, graphite and carbon black

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

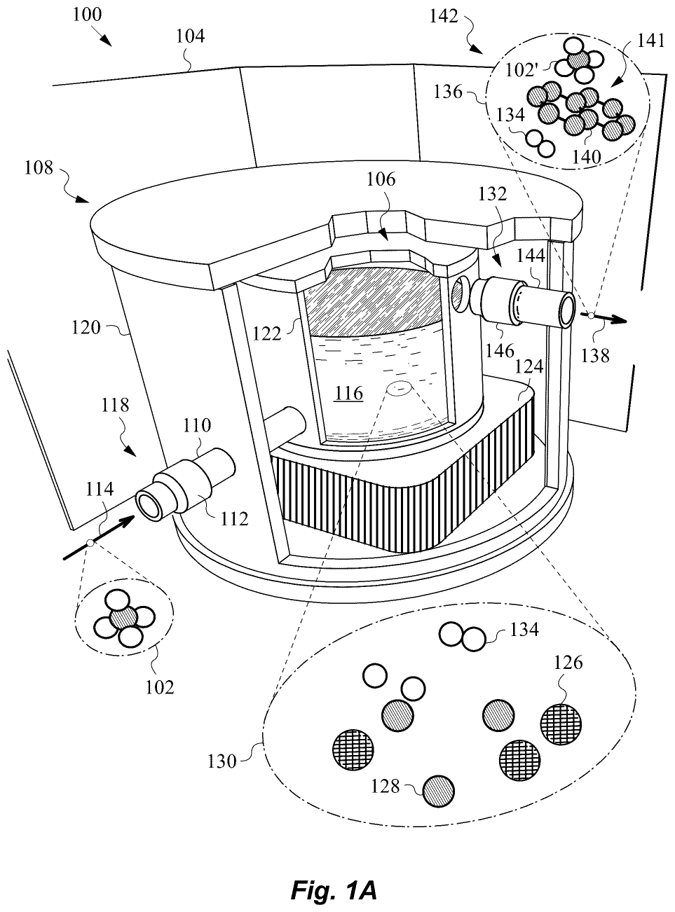

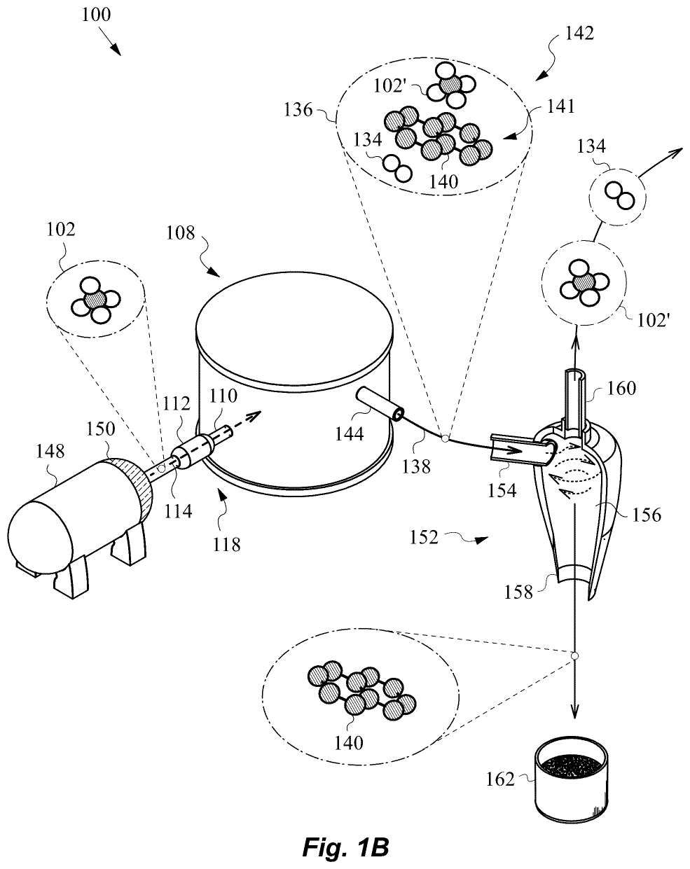

FIG. 1A is a perspective schematic diagram of a decomposition reactor 100 according to the invention. Decomposition reactor 100 is shown in a perspective view with cut-away portions in its main elements for purposes of clear visualization and explanation. FIG. 1A focuses on just the main elements of decomposition reactor 100 and its configuration.

Decomposition reactor 100 is supplied with a hydrocarbon feedstock 102 from a supply (see FIG. 1B). In the present example hydrocarbon feedstock 102 is methane (CH₄) visualized in highly magnified molecular form within a dashed and dotted outline. There are many candidates for use as hydrocarbon feedstock 102 including gases, liquids and solids containing one or more hydrocarbons. Preferably, hydrocarbon feedstock 102 is mostly made up of methane or natural gas. More generally, however, hydrocarbons such as butane, propane, ethane, ethylene, acetylene, propylene, liquified petroleum gas, naphtha, shale oil, wood, biomass, organic waste streams, biogas, gasoline, kerosene, diesel fuel, residual oil, crude oil, carbon black oil, coal tar, crude coal tar, benzene, methyl naphthalene, polycyclic aromatic hydrocarbons and other such hydrocarbons are also suitable for hydrocarbon feedstock 102. In fact, mixtures containing any of the above with other hydrocarbon feedstocks can be used. Also, mixtures containing any of these feedstocks with still others such as mixtures of methane and nitrogen, methane and carbon dioxide or methane and carbon monoxide are suitable as well. The present example focuses on the preferred embodiment in which hydrocarbon feedstock 102 is primarily composed of methane (CH₄).

Decomposition reactor 100 is designed for performing a thermochemical decomposition of hydrocarbon feedstock 102. Such thermochemical decomposition process is also frequently referred to as cracking or direct decomposition. For thermal management reasons, decomposition reactor 100 has an outer wall 104 that provides thermal insulation from the environment. Further, decomposition reactor 100 has within it a thermochemical decomposition reactor 106 in which the actual thermochemical decomposition or cracking of hydrocarbon feedstock 102 takes place. Decomposition reactor 100 has insulating walls that form an enclosure 108 to manage the pressure and contain the heat of thermochemical decomposition reactor 106. In fact, enclosure 108 provides the insulation volume which can be sealed and can maintain an oxidizing, reducing, inert, vacuum or high-pressure environment within which thermochemical decomposition reactor 106 is disposed to operate in accordance with the parameters discussed below.

An inlet supply pipe 110 with a flow regulator 112 are provided for injecting a supply flow 114 of hydrocarbon feedstock 102 into a supersaturated molten mixture 116 held within thermochemical decomposition reactor 106. In the present embodiment, supply pipe 110 and flow regulator 112 operate as a means for injecting or an injection apparatus 118 for supply flow 114. Injection apparatus 118 is arranged such that supply pipe 110 passes through an insulating side wall 120 of enclosure 108. Supply pipe 110 also passes through a side wall 122 of thermochemical decomposition reactor 106. More specifically, supply pipe 110 enters thermochemical decomposition reactor 106 near the bottom of side wall 122. In some cases, injection apparatus 118 has additional elements as discussed below.

FIG. 1A shows thermochemical decomposition reactor 106 with a cut-away portion in order to expose supersaturated molten mixture 116 inside it for visualization purposes. It also shows where supply pipe 110 of injection apparatus 118 passes through side wall 122 near the bottom of side wall 122 coinciding with the bottom portion of supersaturated molten mixture 116. Thus, injection apparatus 118 is configured to pass supply flow 114 of hydrocarbon feedstock 102 through supersaturated molten mixture 116, given that hydrocarbon feedstock 102 will move upwards through supersaturated molten mixture 116, as explained in more detail below.

Decomposition reactor 100 has a heater 124 positioned under thermochemical decomposition reactor 106. Heater 124 is provided for heating supersaturated molten mixture 116 contained inside thermochemical decomposition reactor 106. Heater 124 is also tasked with maintaining supersaturation of molten mixture 116. In the present embodiment heater 124 is an electrical resistive heater. Generally, however, heater 124 can be an induction heater, a microwave heater or a plasma heater. More specifically still, heater 124 can be a gas fired burner, a hydrogen fired burner, an electric arc heater, a natural gas burner, a hydrogen burner, a plasma heater or a thermal energy storage medium. Also, when using an electric arc heater it is possible to arrange it such that it supplies heat to the outside of thermochemical decomposition reactor 106 or directly to supersaturated molten mixture 116. A person skilled in the art will be able to appreciate that still other choices can be made as long as heater 124 is capable of supplying sufficient heat to thermochemical decomposition reactor 106 or directly to molten mixture 116 to achieve and maintain its supersaturation with carbon.

In particular, supersaturated molten mixture 116 is primarily made up of a metal or metal alloy 126 and carbon 128. This is visualized in a highly magnified portion 130 of mixture 116 within a dashed and dotted outline. Metal 126 is preferably either Mn, Fe, Co or Ni or an alloy thereof. More precisely, by primarily made of metal 126 selected from among Mn, Fe, Co and Ni means that supersaturated molten mixture 116 contains >50% Mn, Fe, Co and/or Ni or an alloy thereof.

Now, it is noted that the use of metal 126 in supersaturated molten mixtures is typically avoided in the prior art. As pointed out above, the prior art specifically teaches away from using metals that form carbides during pyrolysis or cracking. However, such metals are not avoided when choosing metal 126 and this choice leads to desirable results when used in accordance with the invention as explained in more detail below.

Decomposition reactor 100 is equipped with a hydrogen extraction means 132 for extracting hydrogen 134 generated by pyrolysis of hydrocarbon feedstock 102 in supersaturated molten mixture 116. Hydrogen 134 is also visualized in a highly magnified portion 136 of a pyrolysis gas flow 138 exiting at the top of thermochemical decomposition reactor 106. Pyrolysis gas flow 138 additionally contains a carbon product 140, as also visualized in highly magnified portion 136. Hydrogen extraction means 132 also carries out or extracts from thermochemical decomposition reactor carbon product 140.

Taken together, hydrogen 134 and carbon product 140 belong to pyrolysis gases 142 obtained by pyrolyzing hydrocarbon feedstock 102 in supersaturated molten mixture 116. Typically, as also shown in magnified portion 136, pyrolysis gases 142 additionally contain an unreacted fraction 102′ of hydrocarbon feedstock 102. Unreacted fraction 102′ is also carried out by hydrogen extraction means 132. However, it is hydrogen 134 and carbon product 140 that constitute desired pyrolysis products 141 according to the invention. Nevertheless, a person skilled in the art will note that the presence of unreacted fraction 102′ in pyrolysis gases 142 can be useful in certain down-stream processes. This is especially true when the proportion of unreacted fraction 102′ is controlled and remains within certain bounds.

Hydrogen extraction means 132 consists of an outlet pipe 144 and a flow control mechanism 146. Flow control mechanism 146 can include a pump for promoting pyrolysis gas flow 138 out of thermochemical decomposition reactor 106. Because of the high temperature of pyrolysis gas flow 138 it is preferable that outlet pipe 144 and flow control mechanism 146 be lined with suitable refractory material.

FIG. 1B is an isometric schematic diagram of decomposition reactor 100 shown with its remaining elements. Specifically, FIG. 1B illustrates a supply 148 of hydrocarbon feedstock 102. Supply flow 114 of hydrocarbon feedstock 102 is derived from supply 148. Supply 148 includes a purifying system 150 that removes sulphur and any other undesirable components from hydrocarbon feedstock 102. In addition to purifying system 150, supply 148 can also have separation systems and/or gasification systems. Such systems can be used to further purify hydrocarbon feedstock 102 prior to thermal decomposition. A person skilled in the art will note that such systems are known from typical reactors designed for cracking hydrocarbon feedstocks.

Decomposition reactor 100 is further equipped with a carbon separation means 152 for separating carbon product 140 obtained by pyrolyzing hydrocarbon feedstock 102. Carbon separation means 152 can be a high-temperature cyclone, a low-temperature cyclone, a high-temperature candle filter, a combination of both including a series of such devices. Still other choices include separation systems such as bag filter systems.

In the present embodiment, carbon separation means 152 is a high-temperature cyclone. High-temperature cyclone 152 is designed to operate at high temperatures because pyrolysis gases 142 exit thermochemical decomposition reactor 106 (see FIG. 1A) at high temperatures, typically above 800° C. and even above 1,000° C. Thus, the function of high-temperature cyclone 152 is to receive pyrolysis gas flow 138 from outlet pipe 144 and to separate carbon product 140 from pyrolysis gases 142 that include hydrogen 134 and any unreacted fraction 102′ of hydrocarbon feedstock 102. To perform this function high-temperature cyclone 152 has a peripheral cyclone inlet 154 for admitting pyrolysis gas flow 138 into an interior chamber 156 where solid-gas separation takes place. A majority of the large and heavy carbon product 140 drops out under gravity through a bottom outlet 158 while gases including hydrogen 134 and some unreacted fraction 102′ leave through outlet pipe 160. A collection vessel 162 is positioned below bottom outlet 158 for collecting carbon product 140.

In some embodiments additional systems can be positioned after thermochemical decomposition reactor 106 to separate out and purify products of thermal decomposition. There may also be included systems to recycle unreacted fraction 102′ and recycle heat from pyrolysis gases 142 to hydrocarbon feedstock 102 in inlet supply flow 114. Many such systems are well-known to a person skilled in the art and such auxiliary systems can be used in decomposition reactor 100. Furthermore, hydrocarbon feedstock 102 as used herein includes hydrocarbons that may have already been purified, separated, mixed, or otherwise acted upon by auxiliary systems.

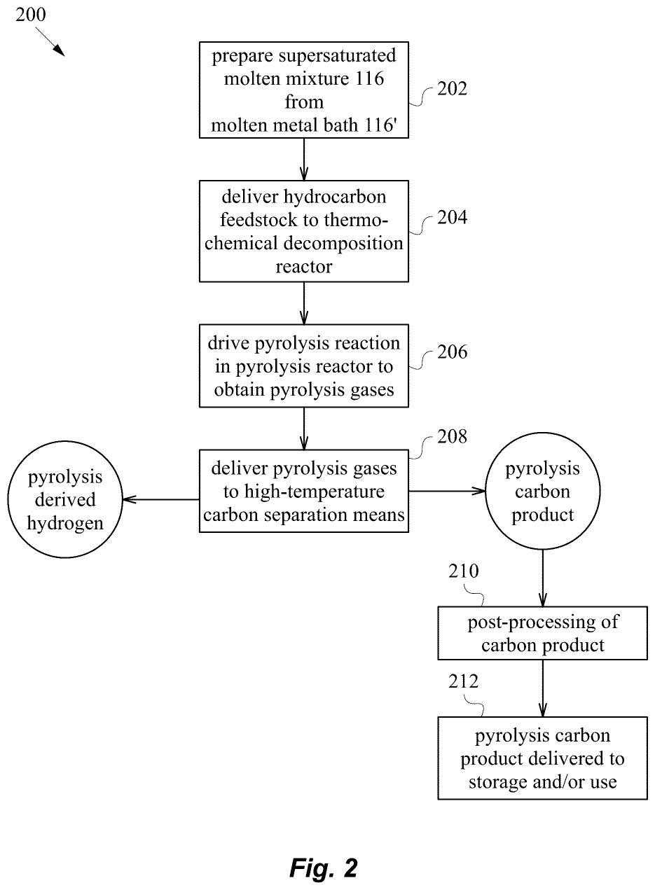

FIG. 2 is a flow diagram 200 that explains the operation of decomposition reactor 100 with reference to elements illustrated in FIGS. 1A-B. Flow diagram 200 focuses on important aspects of preparation for pyrolysis of hydrocarbon feedstock 102 as well as cracking or pyrolysis itself. Further, flow diagram 200 covers the processing of carbon product 140 and treatment of pyrolysis gases 142.

In a first step 202 and before performing pyrolysis it is necessary to obtain supersaturated molten mixture 116 from an initial molten metal bath 116′. (Note that only the already supersaturated molten mixture 116 rather than initial molten metal bath 116′ is shown in FIG. 1A). First step 202 depends on the starting or initial conditions of the bath or solid in thermochemical decomposition reactor 106.

In some cases, molten metal bath 116′ is started by melting metal 126 with a carbon content that has less carbon 128 than required for a fully saturated metal carbide state of metal 126 and then carburizing metal 126. Carburizing means adding carbon 128. Carburization is most effectively accomplished by performing pyrolysis of a hydrocarbon such as hydrocarbon feedstock 102. Since delivering hydrocarbon feedstock 102 is part of a second step 204 of the process this is a simple scenario for obtaining supersaturated molten mixture 116. Differently put, this scenario starts out with undersaturated molten metal bath 116′ and then obtains desired supersaturated molten mixture 116 by executing step 204. Such “in situ” preparation of supersaturated molten mixture 116 is advantageous since once achieved one then simply continues to step 206 that drives the desired pyrolysis reaction.

In other cases, molten metal bath 116′ is a pool or body of molten metal 126. In still other cases one may even commence with solid metal 126 that is placed in thermochemical decomposition reactor 106. Then the mixture of metal 126 and solid carbon 128 are heated together to a sufficient temperature such that the metal phase melts and solid carbon 128 is solubilized into the melt. In this case solid carbon 128 can be introduced into thermochemical decomposition reactor 106 in an either crystalline or amorphous form.

In still another case, molten metal bath 116′ is created by melting a metal carbide from a previously saturated metal carbide solution. This embodiment is preferred in cases where the material of the crucible of thermochemical decomposition reactor 106 is made of carbon or graphite, such that liquid metal 126 does not react or try to uptake carbon from the crucible material. Other suitable crucible or reactor materials are refractory materials such as aluminum oxide (Al₂O₃) based refractories, calcium oxide (CaO) based refractories and magnesium oxide (MgO) based refractory materials. Stable metal carbide materials such as silicon carbide and aluminum carbide may be used as crucible materials as well because they have better high temperature stability in comparison to carbides of Mn, Fe, Co and Ni.

In order to achieve supersaturated molten mixture 116 of metal 126 and carbon 128 when metal 126 is Mn, Fe, Co or Ni temperatures of over 1,100° C. are required. Indeed, heater 124 needs to maintain the supersaturated molten mixture in a state of supersaturation with carbon and this requires that it keep a temperature between 1,100° C. and 2,000° C. since high enough solubility of carbon in metal is achieved at such high temperatures. When supersaturated, molten mixture of metal and carbon is in a condition above a miscibility limit. At this point any additional carbon either precipitates as a solid from the molten mixture or simply cannot be dissolved into the liquid state.

Preferably, the temperatures are maintained over 1,300° C. It is important to note that these temperatures are higher than in many prior art efforts on hydrocarbon pyrolysis in molten baths, but they are necessary to maintain the bath in liquid state. Again, note that the term bath is used to define a pool or body of molten metal 126. The benefit of such high bath temperature is that the pyrolysis reaction rate proceeds very quickly. For example, methane (CH₄) only needs to be maintained at 1,350° C. for under 1 second to achieve a >90% reaction yield of methane to carbon product 140 and hydrogen 134.

Heat must be continuously input from heater 124 into the molten material in order to maintain the bath temperature. That is because the hydrocarbon decomposition reaction or pyrolysis is endothermic. Furthermore, hydrocarbon feedstock 102 in supply flow 114 may be colder than the molten material prior to injection into thermochemical decomposition reactor 106; yet another reason for continuous input of heat from heater 124.

An additional benefit of operating at such high temperatures is that the height or depth of supersaturated molten mixture 116 does not need to be large in order to achieve high pyrolysis reaction yields. A bath depth of only about 2 cm is necessary. However, greater depths such as approximately 10 cm, or approximately 15 cm or more are preferred in order to achieve sufficient residence time of hydrocarbon gas, here methane CH₄, inside supersaturated molten mixture 116 to reach high pyrolysis yield in forming hydrogen 134. Indeed, greater depths than 10 cm can be employed, and even up to several meters, when yields of greater than 95% and possibly greater than 98% are desired.

While molten metal bath 116′ should be primarily composed of metal 126 represented by Mn, Fe, Co or Ni or an alloy thereof, other metals can be present in or introduced into molten metal bath 116′. These additional metals are kept down to concentrations of less than 50% and are designed to perform useful functions. For example, they may act as catalysts to aid in hydrocarbon pyrolysis. They may act as intentional impurities. They may also act as additives to lower the melting temperature of molten metal bath 116′. For example, silicon and aluminum are both readily soluble in Mn, Fe, Co and Ni and can be added to lower the melting temperature of these metals. Other common additives in Mn, Fe, Co and Ni include chromium (Cr), molybdenum (Mo) and tungsten (W). Additionally, conventional liquid metals (Pb, Sn, Bi, In and Ga) can be alloyed with Mn, Fe, Co or Ni in order to lower the melting point of molten metal bath 116′. Alloying up to 50% is permissible such that the melting point of molten metal bath 116′ is below 1,200° C. This is done to alleviate the high temperature requirements on heather 124 and insulation materials of thermal decomposition reactor 106.

As already mentioned, the temperature of supersaturated molten mixture 116 of metal 126 and carbon 128 is maintained by inputting energy from heater 124. While heater 124 is an electrical resistive heater in the present embodiment, heating by using electrical induction, combustion, plasma or using microwave heat transfer are also viable. However, resistive heating as provided for by heater 124 or inductive heating are preferred in order to maintain the high temperature of the pyrolysis process without creating carbon dioxide emissions. In fact, when using electricity to heat molten metal bath 116′ and ultimately supersaturated molten mixture 116 it is preferable that the electricity be derived from renewable energy sources. Such renewable sources include geothermal, wind, solar energy, solar photovoltaics or nuclear energy. In other embodiments the heat for turning molten metal bath 116′ into supersaturated molten mixture 116 and driving the pyrolysis process can be supplied via the thermal energy from nuclear energy. In still other embodiments, the heat for turning molten metal bath 116′ into supersaturated molten mixture 116 and driving the pyrolysis process can be supplied via thermal energy that has been stored in a thermal mass. Suitable materials for such a thermal mass include graphite, Mn, Fe, Co, Ni, refractory bricks primarily composed of Al₂O₃, SiC and still other suitable refractory materials.

Second step 204 of the process is performed once supersaturated molten mixture 116 is obtained from initial molten metal bath 116′. During step 204 hydrocarbon feedstock 102 is delivered to thermochemical decomposition reactor 106. During step 204 flow regulator 112 of injection apparatus 118 ensures that supply flow 114 of hydrocarbon feedstock 102 is injected into supersaturated molten mixture 116 held within thermochemical decomposition reactor 106.

It is preferable that during step 204 and during subsequent steps supersaturated molten mixture 116 be held within thermochemical decomposition reactor 106 inside decomposition reactor 100 such that any formation of metal oxides and gaseous CO and CO₂ be kept to a minimum. Thus, it is preferred that the inside of thermochemical decomposition reactor 106 have a low concentration of oxygen and water and present an inert environment.

During step 206 pyrolysis reaction is driven in thermochemical decomposition reactor 106 in the inert, oxygen- and water-poor environment under conditions that maintain supersaturation with carbon. In other words, the flow rate of supply flow 114 as well as the amount of heat delivered by heater 124 are tuned to ensure that supersaturated molten mixture 116 is maintained in the supersaturated state. More specifically, the tuning of supply flow 114 and heat delivery from heater 124 is such that the pyrolysis temperature or decomposition temperature is typically above 1,000° C. In some cases, the decomposition temperature is even above 1,200° C. Information about thermochemical decomposition parameters of hydrocarbons suitable for use as hydrocarbon feedstock 102 in supply flow 114 is available in the literature. The reader is here referred to M. Wullenkrod, “Determination of Kinetic Parameters of the Thermal Dissociation of Methane”, Ph.D. Dissertation, Lehrstuhl fur Solartechnik (DLR), RWTH Aachen University, 2012 as well as S. Rodat et al., “Kinetic modelling of methane decomposition in tubular solar reactor”, Chemical Engineering Journal, 146 (2009), pp. 120-127.

Advantageously, while supersaturated molten mixture 116 remains supersaturated carbon pyrolysis gases 142 obtained from thermochemical decomposition reactor 106 in step 206 will contain hydrogen 134 and carbon product 140. Again, hydrogen 134 and carbon product 140 constitute pyrolysis products 141 that are desired. Advantageously, a portion of carbon product 140 obtained under these conditions will be highly graphitic. Indeed, this is the reason for schematically illustrating carbon product 140 with graphite in FIGS. 1A-B, although clearly not all carbon product 140 will actually be in the form of graphite.

Furthermore, given that thermochemical decomposition reactor 106 maintains a low concentration of oxygen and water and presents an inert environment, hydrogen 134 and carbon product 140 do not form gaseous CO and CO₂. Additionally, the inert atmosphere is preferable so that supersaturated molten mixture 116 does not become oxidized, thus forming metal oxides and gaseous CO and CO₂.

The use of supersaturated molten mixture 116 differentiates the present invention from the prior art since metals which form carbides are typically avoided in prior art methane pyrolysis. As already remarked, the prior art teaches the usage of molten metals or salts which do not form carbides, oxidation of any carbides, or the usage of unstable carbides. In the present invention, however, the use of supersaturated molten mixture 116 that does have metals that normally form carbides is in fact desired, since carbide formation is suppressed while supersaturation is maintained. The use of supersaturated molten mixture 116 containing carbon specifically enables the desired formation of crystalline or graphitic carbon product 140 rather than amorphous carbon.

Further, in the prior art focused on methane or hydrocarbon pyrolysis in molten media to form hydrogen and solid carbon the hydrocarbon feedstock gas is injected into the molten media through an orifice or set of orifices which can be referred to as a bubble column or bath of molten metal. This hydrocarbon gas rises upwards through the molten media by buoyancy and is heated by the molten media to a temperature at which the hydrocarbon gas undergoes catalytic or thermal decomposition into primarily hydrogen and solid carbon. It is noted that other gasses such as ethane, ethylene, acetylene and benzene can be formed as well. When the pyrolysis products consisting of hydrogen and carbon reach the surface of the molten media bath, they break through this top surface causing a gas bubble containing solid carbon product to burst. The hydrogen is then extracted off the top of the molten media bath. The solid carbon also rises to the top of the molten media bath by buoyancy as it is typically less dense than the molten media material, thus allowing it to also be separated from the bubble column or molten media bath.

In contrast to the prior art, in step 206 the present invention focuses specifically on performing pyrolysis of hydrocarbon feedstock 102 in supersaturated molten mixture 116 to form pyrolysis products 141 primarily composed of hydrogen 134 and carbon product 140. Supersaturated molten mixture 116 of metal 126 and carbon 128 is composed of liquid phase metal 126 that is miscible with carbon 128 up to a miscibility limit. Above this miscibility limit liquid phase metal 126 is supersaturated with carbon 128. Thus, additional carbon 128 is either precipitated as solid from supersaturated molten mixture 116 or it simply cannot be dissolved into the liquid state.

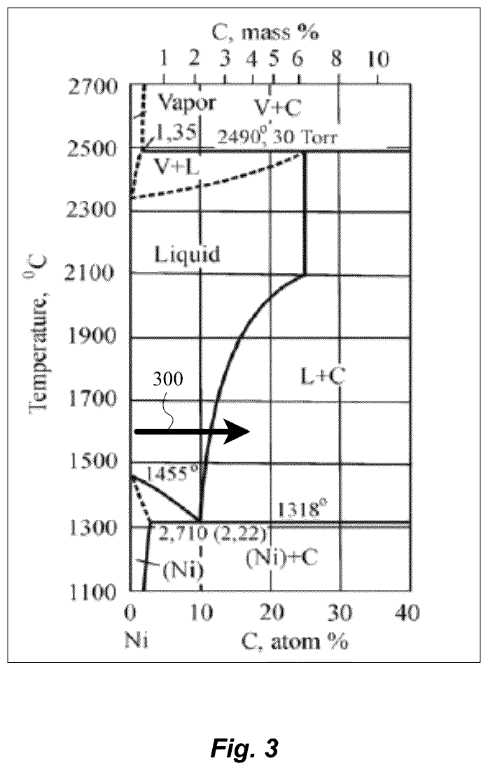

It should be noted that unlike in the prior art that teaches forming a carbide with a catalytic substance and subsequently decomposing the formed carbide, the present invention does not require carbide formation and decomposition. Rather, the present invention focuses on continuous formation of carbon product 140 and precipitation from the supersaturated carbon-containing molten mixture 116 that may form stable carbides or may not form any carbides at all. Furthermore, note that nickel carbides are thermodynamically unlikely to form below a temperature of 2,100° C., as shown in the Ni—C phase diagram in FIG. 3 discussed below. Indeed, more recent studies such as Jiao, M., Li, K., Guan, W. et al. Crystalline Ni₃C as both carbon source and catalyst for graphene nucleation: a QM/MD study. Sci Rep 5, 12091 (2015). https://doi.org/10.1038/srep12091 show that “crystalline Ni₃C is unlikely to be a reaction intermediate in the CVD-growth of graphene at high temperatures”. Houdry Process Corp has built upon this prior art as described in U.S. Pat. No. 2,794,709 from 1952 by teaching a metal bath which “comprises copper and 30% tin”.

Now, specifically in embodiments where metal 126 is Ni the solubility of carbon 128 increases with temperature. Further, the solubility increases significantly when Ni is in molten or liquid state. This is shown in the Ni—C phase diagram of FIG. 3 provided by Gromov, D. & Gavrilov, S., “Thermodynamics—Physical Chemistry of Aqueous Systems. Heterogeneous Melting in Low-Dimensional Systems and Accompanying Surface Effects”, 2011, pgs. 157-190. Note that the term molten and liquid are used interchangeably in the present description, as is commonly accepted among those skilled in the art. Further “V” stands for vapor phase and “L” stands for liquid phase in the Ni—C phase diagram of FIG. 3.

Clearly, at 1,400° C. carbon 128 is soluble in molten metal 126 here embodied by Ni. This remains true until the concentration of carbon 128 in Ni exceeds approximately 10 atomic %. Additional carbon 128 is not soluble in molten metal 126 (Ni) and carbon 128 solution at 1,400° C. Instead, such additional carbon 128 coexists as a solid with supersaturated molten mixture 116 of metal 126 (Ni) and carbon 128. This region is designated as “L+C” in the Ni—C phase diagram shown in FIG. 3. Furthermore, arrow 300 indicates this region as well.

According to the invention, during step 206 supersaturated molten mixture 116 of metal 126 (Ni) and carbon 128 needs to be maintained in the region of the phase diagram indicated by arrow 300. This is achieved by tuning the amount of heat delivered to supersaturated molten mixture 116 from heater 124 and the flow rate of supply flow 114 being injected into supersaturated molten mixture 116. Note that the Ni—C phase diagram also shows that liquid metal 126 (Ni) becomes fully saturated with carbon 128 at 25 atomic % above 2,100° C. to form a Ni₃C phase. If this liquid Ni₃C phase were rapidly cooled or quenched to room temperature, the Ni₃C, referred to as nickel carbide, would be considered metastable. A metastable composition implies that the mixture of atoms is not in a state of lowest energy and is instead locked in an intermediate higher energy state.

We note that all of Group 7, 8, 9, 10 and 11 metals could in principle be considered for metal 126 as they form supersaturated mixtures with carbon 128 and could form metastable molten metal carbides. However, the use of Tc, Ru, Pd, Ag, Re, Os, Ir, Pt and Au at concentrations over 5% by weight would be highly impractical from a cost perspective. Nearly all of these transition metals populating row 5 and row 6 of the periodic table are among the rarest metals and often considered to be precious metals. Their use would thus defy the objective of producing low-cost hydrogen 134 and carbon product 140. Therefore, in preferred embodiments of the invention pyrolysis of hydrocarbon feedstock 102 relies on metal 126 that is a transition metal chosen from row 4 of the periodic table. These metals include Manganese (Mn), Iron (Fe), Cobalt (Co) and Nickel (Ni). It will be apparent to one skilled in the art, however, that the present invention can be practiced with any element, alloy, salt or material that will form a supersaturated mixture of carbon 128 at temperatures that are practicable for pyrolysis of hydrocarbon feedstock 102.

Performing pyrolysis of hydrocarbon feedstock 102 in supersaturated molten mixture 116 of metal 126 like Mn, Fe, Co or Ni and carbon 128 means that additional carbon 128 introduced during pyrolysis driven in step 206 causes supersaturated molten mixture 116 to transition into two-phase region. In the case where metal 126 is Ni this two-phase region is indicated by arrow 300 in FIG. 3. In two-phase region 330 between liquid metal 126 and carbon 128 crystalline carbon and liquid metal 126 coexist. The formation of crystalline carbon rather than amorphous carbon enables the creation of valuable carbon product 140 and to improve the economics of the hydrocarbon pyrolysis process. Crystalline forms of carbon include diamond, graphite, graphene, carbon nanotubes and fullerenes. It has been found that performing pyrolysis of hydrocarbon feedstock 102 in supersaturated molten mixture 116 leads particularly to the formation of carbon with graphene, diamond and graphite crystal structures. Carbon product 140 containing these types of carbon structures is very valuable.

Not all of carbon product 140 obtained in step 206 will be crystalline. A fraction of carbon product 140 will be amorphous. However, a significant realization made in the present invention is that a considerable portion (>10%) of any additional carbon 128 introduced into supersaturated molten mixture 116 of metal 126 and carbon 128 becomes crystalline. This is a surprising result, since the phase diagram of FIG. 3 would suggest that this additional carbon 128 cannot dissolve in supersaturated molten mixture 116. In fact, continuous production of carbon product 140 with a considerable content of crystalline carbon, typically in the form of graphite (illustrated in FIGS. 1A-B) without the oxidation of carbon 128 or temperature cycling to transition between supersaturated molten mixture 116 and molten metal bath 116′ to force precipitation is a major advantage of the present invention.

In a preferred embodiment of step 206, when metal 126 is Ni, pyrolysis is driven within indicated region 300 of the phase diagram (see FIG. 3) and with appropriate tuning of heat delivered by heater 124 and rate of supply flow 114 of hydrocarbon feedstock 102 (which is typically cold) to yield a significant fraction of crystalline carbon in carbon product 140. Preferably, the significant fraction of crystalline carbon is more than 5%, or more than 10%, or more than 25%, or more than 50%, or more than 75%, or even more than 90% of carbon product 140. The crystalline carbon fraction in carbon product 140 is preferably highly crystalline, dense, graphitic carbon as characterized by having a Brunauer-Emmett-Teller (BET) surface area<10 m²/g and even more preferably a BET surface area<9 m²/g accompanied by X-ray diffraction (XRD) d002 mean interlayer graphite spacing of <3.4 Angstroms or <0.34 nm and even more preferably <3.36 Angstroms or 0.336 nm, and an X-ray diffraction full-width half maximum (FWHM) of the d002 peak of <0.1 degrees and even more preferably <0.08 degrees and even more preferably still <0.06 degrees.

It should be noted that commercial carbon blacks typically have BET surface areas of 9-138 m²/g or even higher for non-rubber blacks which range from 148-295 m²/g. Further, carbon black is composed of small crystallites which are made up of parallel graphitic layers with an XRD d002 spacing of approximately 0.350 to 0.380 nm in contrast to graphite at 0.335 nm. The reader is referred to Jean-Baptiste Donnet, “Carbon Black: Science and Technology”, CRC Press, 1993 for additional data about carbon black and its parameters.

Returning to flow diagram 200 of FIG. 2, we note step 208 in which pyrolysis gases 142 that carry pyrolysis products 141, and specifically hydrogen 134 and carbon product 140 that is highly graphitic, i.e., having a significant fraction of crystalline carbon, are delivered to carbon separation means 152 (also see FIG. 1B). Preferably, step 208 involves fluidizing carbon product 140 and the solid carbon it contains out of thermochemical decomposition reactor 106 and delivering it to carbon separation means 152 at high temperature. In some embodiments of step 208 >50% and preferably >90% of the solid carbon produced through pyrolysis in thermochemical decomposition reactor 106 is fluidized out of it with the aid of hydrogen extraction means 132. During step 208 flow control mechanism 146 of hydrogen extraction means 132 promotes pyrolysis gas flow 138 out of thermochemical decomposition reactor 106. As noted above, because of the high temperature of pyrolysis gas flow 138, typically above 900° C., it is preferable that outlet pipe 144 and flow control mechanism 146 be lined with suitable refractory material.

Whenever supply flow 114 carries hydrocarbon feedstock 102 primarily composed of methane and pyrolysis in thermochemical decomposition reactor 106 yields pyrolysis products 141 that are primarily composed of hydrogen 134 and carbon product 140 that is in the form of solid carbon (e.g., graphitic carbon), it is preferable that carbon product 140 be removed in a continuous manner. It is particularly advantageous in this case to fluidize carbon product 140 and the solid carbon it contains out of thermochemical decomposition reactor 106. The fluidization is performed by pyrolysis gases 142, and more specifically by hydrogen 134 and any unreacted fraction 102′ of hydrocarbon from the reaction. In order to fluidize out carbon product 140 composed of solid carbon, a sufficient fluidization velocity of pyrolysis gas flow 138 must be maintained in the headspace of thermochemical decomposition reactor 106 to carry the solid carbon. In other words, the velocity of pyrolysis gases 142 constituting pyrolysis gas flow 138 moving from the headspace above supersaturated molten mixture 116 into outlet pipe 144 of extraction means 132 needs to be sufficiently high to carry the solid carbon.

In some embodiments the fluidization velocity of pyrolysis gas flow 138 can be increased by introducing a supplemental gas stream (not shown). The supplemental gas stream can be introduced into either the molten material of supersaturated molten mixture 116 or into the headspace above it. The supplemental gas is preferably an inert gas such as nitrogen, argon, helium or hydrogen. However, supplemental gas could also comprise a hydrocarbon or carbon oxide gas such as carbon dioxide or carbon monoxide. In alternative embodiments, thermochemical decomposition reactor 106 is operated intermittently or semi-continuously such that the solid carbon of carbon product 140 created in the pyrolysis reaction is removed in batches rather than continuously.

Step 208 also includes separating carbon product 140 from hydrogen 134 and any unreacted hydrocarbon fraction 102′ in hot pyrolysis gas flow 138. Preferably, carbon separation means 152 removes >90% of the fossil-derived carbon from decomposition reactor 100. In the preferred embodiment carbon separation means 152 is a high temperature cyclone (as shown in FIG. 1B) as it is capable of minimizing the formation of CO and CO₂ while removing particulates from pyrolysis gas flow 138. The design of cyclones for solid-gas separation is well understood by those skilled in the art.

As pyrolysis gas flow 138 carrying carbon product 140 that includes solid carbon enter cyclone 152 it will rotate around outlet pipe 160 at lower pressure. The majority of solid carbon of carbon product 140 will drop out through bottom outlet 158 with gravity while the remaining pyrolysis gas flow 138 carrying hydrogen 134 and unreacted fraction 102′ will exit upwards through outlet pipe 160. The diameters of peripheral cyclone inlet 154 and outlet pipe 160 and the pressure drop through cyclone 152 are key parameters in determining its separation efficiency. Separation efficiency is a measure of how efficiently solid particles are separated from pyrolysis gas flow 138. Typically, larger particles are much easier to separate than smaller particles. Therefore, a series of cyclones like cyclone 152 (not shown) can be used to ensure separation of the majority of solid carbon. Again, cyclone design parameters and optimization are well-known to those skilled in the art and should be tuned accordingly to achieve this desired separation of solid carbon from pyrolysis gas flow 138.

At the end of step 208 hydrogen 134 is delivered downstream for storage or use. Similarly, carbon product 140 is also delivered downstream for either storage or use. Exemplary uses of carbon product 140 are discussed below.

An optional post-processing step 210 can be applied to carbon product 140 after separation. It will be apparent to one skilled in the art that such further post-processing can include post-treatment of solid carbon contained in carbon product 140. This includes post-treatments such as graphitization at temperatures over 2,000° C., milling, particle classification and other common carbon solid and powder treatment techniques. These techniques are commonly used to alter and improve upon any of the parameters listed above. It will also be apparent to one skilled in the art that it is preferable to reduce post-treatments of solid carbon in carbon product 140 as much as possible by creating solid carbon in supersaturated molten mixture 116 of thermochemical decomposition reactor 106 that is as close as possible to the preferred parameters listed above. Further, it will be apparent to one skilled in the art that formation of solid carbon in thermochemical decomposition reactor 106 as described in the present invention will result in some level of contamination of the solid carbon in carbon product 140 with molten material from supersaturated molten mixture 116. The level of contamination of the solid carbon with any molten material should be as low as possible. Hence, post-treatment of solid carbon could include steps such as purifying and reducing contamination of the solid carbon by the molten material.

Finally, in step 212 carbon product 140 is delivered to collection vessel 162. Carbon product 140 can be stored in collection vessel 162 and/or delivered for downstream use, as remarked above. In fact, carbon product 140 containing crystalline carbon such as graphite or graphene finds many applications. In a preferred embodiment, the electrical conductivity of the graphite produced according to the invention is leveraged for the creation of electrodes in electric arc furnaces, batteries and supercapacitors. Further, the high thermal stability of graphite also makes it suitable for use as a high temperature refractory or insulation material. Finally, graphite formed in accordance with the invention can be used as a lubricant or it can be used in brake lining or in pencils.

As already noted above, metal 126 in supersaturated molten mixture 116 can be selected from among Mn, Fe, Co, Ni and Cu. The previously described embodiments focused on cases in which metal 126 was Ni. We now focus on the other choices of metal 126 and the corresponding phase diagrams that indicate the proper supersaturation regions for operation in accordance with the invention.

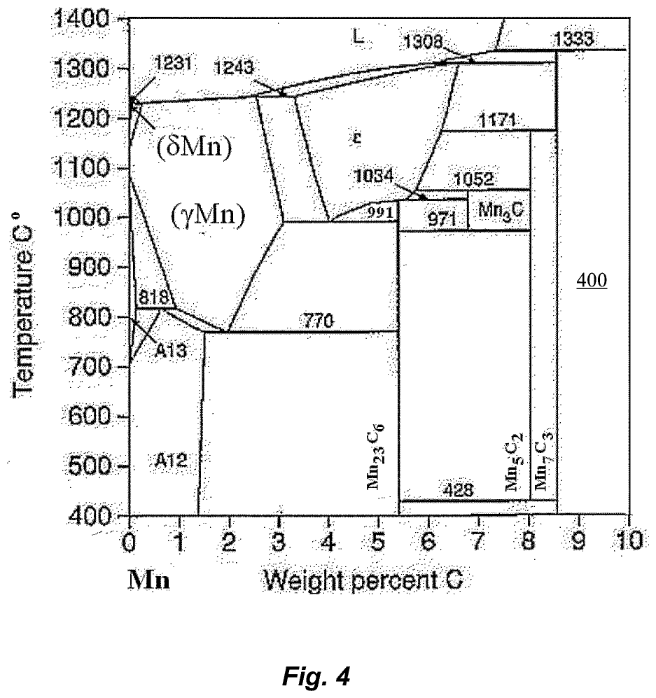

FIGS. 4-7 show the phase diagrams of Mn, Fe, Co and Cu, respectively. When choosing metal 126 for supersaturated molten mixture 116 to be Mn, Fe, Co or Cu it is important to consider the characteristics of their corresponding phase diagram. Characteristic of each of these phase diagrams is a region where metal 126 and carbon 128 form a fully liquid mixture at low carbon concentrations and a liquid plus carbon (L+C) or liquid plus graphite region at high concentrations.

FIG. 4 illustrates the phase diagram for Mn where liquid plus graphite region is indicated by reference 400. Mn—C phase diagram is openly available and can be found in many sources. An exemplary source is Sichen, D., Seetharaman, S. & Staffansson, L. I. Some phase-diagram aspects of the manganese-carbon system. Metall Trans B 20, 747-754 (1989). https://doi.org/10.1007/BF02655933). Mn is a good choice for metal 126 based on solubility of carbon and low operating temperature.

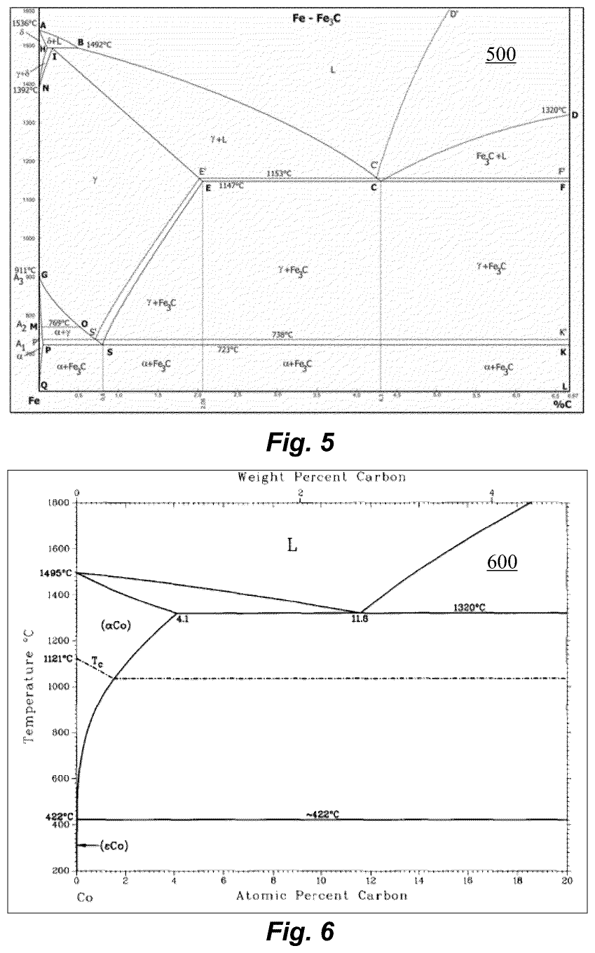

Fe is also a good choice for metal 126 and exhibits an accessible liquid plus carbon region designated by reference 500, as shown in FIG. 5. As in the case of Mn—C the Fe—C phase diagram is openly available and can be found in many sources including at: https://fractory.com/iron-carbon-phase-diagram/. Finally, Co is also a good choice for metal 126. This is evidenced by liquid plus carbon region 600 in the phase diagram of FIG. 6 (Co—C phase diagram. Source: Ishida, K., Nishizawa, T. The C—Co (Carbon-Cobalt) system. JPE 12, 417-424 (1991). https//doi.org/10.1007/BF02645959).

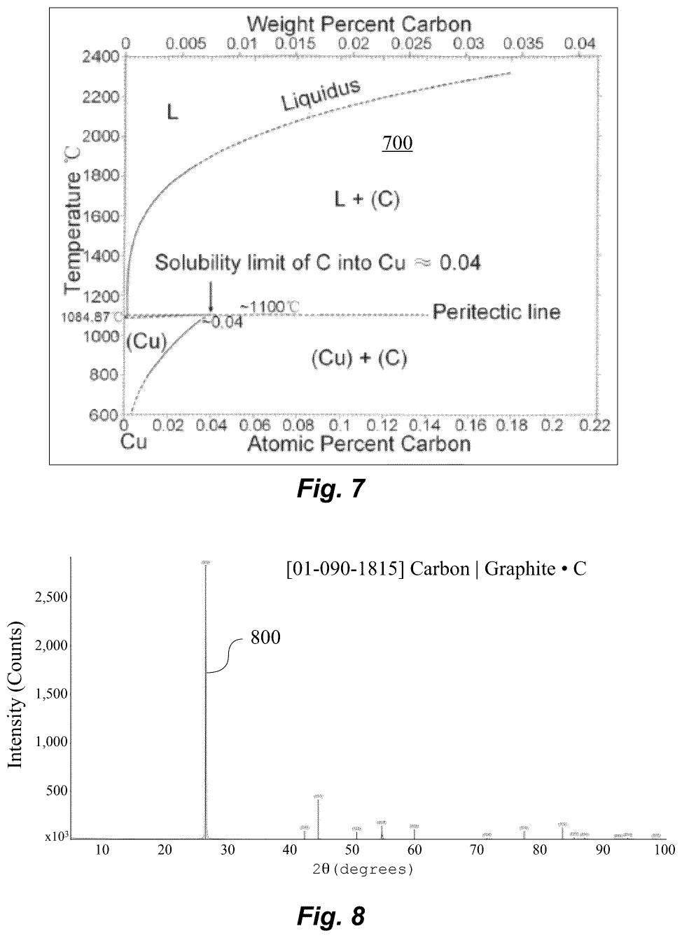

In fact, for the purpose of obtaining carbon product 140 composed of a significant proportion of graphite according to the invention choosing Mn, Fe, Co and Ni over Cu as metal 126 is preferable. This is because the solubility limit of carbon in Cu is very low, as seen from the phase diagram for Cu—C shown in FIG. 7 (Source: Silvain, J.-F & Heintz, Jean-Marc & Veillere, A. & Constantin, Loic & Lu, Y. (2019). A review of processing of Cu/C base plate composites for interfacial control and improved properties. International Journal of Extreme Manufacturing. 2. 10.1088/2631-7990/ab61c5). At 1,600° C. the solubility of carbon in Cu is only about 0.01 atomic % while the solubility at 1,600° C. in Mn, Fe, Co and Ni is approximately 30%, 25%, 15% and 12%, respectively (see phase diagrams in FIGS. 3-6). Differently put, carbon is over three orders of magnitude more soluble in Mn, Fe, Co and Ni than in Cu. Additionally, Mn, Fe, Co and Ni all form metastable metal carbides (indicated in their respective phase diagrams) when quenched from high temperature. These metastable metal carbides slowly decompose under atmospheric pressure and at room temperature to metal and graphite.

With respect to Mn in particular, it forms several carbides such as Mn₂₃C₆, Mn₁₅C₄, Mn₃C, Mn₇C₃. However, Mn does not form a metastable carbide with more carbon than in Mn₇C₃ at 30% carbon content. Similarly, there are several phases of carbon and Fe mixtures, with a common one being referred to as steel, but the saturated state of iron carbide is known as cementite with the formula Fe₃C. Ishida and Nishizawa (op. cit.) found that there are two metastable phases of Co and carbon: Co₂C and CO₃C. Finally, Ni has two main metastable phases, namely Ni₉C and Ni₃C, although Ni₃C can only be obtained from very high temperatures over 2,100° C.

It will be appreciated that decomposition reactor 100 and the method of operating it admit of many modifications and alternatives. For example, although supply flow 114 that carries hydrocarbon feedstock 102 is injected through side wall 122 of thermochemical decomposition reactor 106 in the above embodiments, it is possible to change the injection geometry in other embodiments. Thus, in some embodiments supply flow 114 is injected through the bottom of thermochemical decomposition reactor 106. In other embodiments supply flow 114 is injected into supersaturated molten mixture 116 through its top surface. In fact, any injection geometry is admissible as long as the injection satisfies the condition that hydrocarbon feedstock 102 passes through supersaturated molten mixture 116 and is pyrolyzed to yield desired pyrolysis products 141 that primarily include hydrogen 134 and carbon product 140.

In embodiments where pyrolysis of hydrocarbon feedstock 102 in supersaturated molten mixture 116 leads to the formation of hydrogen 134 and carbon product 140 with a considerable fraction of solid carbon additional modifications can be adopted. This is especially so in cases where the solid carbon is highly crystalline and the highly crystalline carbon phase is in the form of graphene, graphite, fullerenes, carbon nanotubes or diamond. The formation of this crystalline phase of carbon through pyrolysis of hydrocarbon feedstock 102 in supersaturated molten mixture 116 of metal 126 that is selected from among Mn, Fe, Co and Ni is ascertained through suitable measurement.

FIG. 8 is an x-ray diffraction (XRD) plot that is produced by graphite formed during the pyrolysis reaction. A sharp peak 800 in the XRD plot indicates the presence of the crystalline phase. Raman spectroscopy is a helpful tool for identifying the exact crystalline phase of carbon in carbon product 140. Specifically, Raman spectroscopy can distinguish between carbon nanotubes, diamond, fullerenes, graphene and graphite.

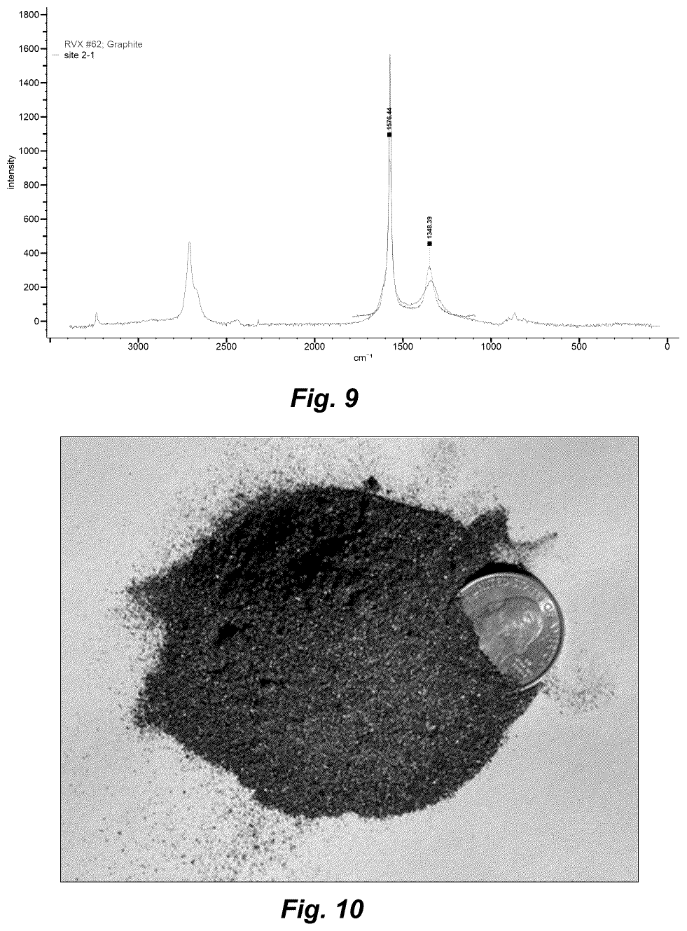

FIG. 9 is a Raman spectroscopy spectrum for the crystalline carbon formed during pyrolysis of hydrocarbon feedstock 102 in accordance with the invention. The different peaks correspond to the different crystalline carbon phases. In Raman spectroscopy of carbon materials, the D and G peaks are two prominent features that provide key information about the structure and quality of the material, especially for graphitic materials such as graphite, graphene, carbon nanotubes and amorphous carbon. The G peak (or G band) is positioned around 1,580 cm⁻¹ and corresponds to the E2g phonon mode of sp² hybridized carbon atoms (like in graphite or graphene). It arises from the in-plane vibration of carbon atoms in a hexagonal lattice. This peak is typically associated with the presence of ordered graphitic structures. The D peak is positioned around 1,350 cm⁻¹ and is a result of a breathing mode of A₁g symmetry involving out-of-plane vibrations that require the presence of a defect or disorder to be activated. It arises from sp² carbon atoms at defect sites or at edges. These peaks can be observed in FIG. 9 and the high G peak is indicative of graphite. The ratio of intensities of the D peak (I D) to the G peak (I G) is often used to quantify the level of disorder in carbon materials. A lower I D/I G ratio indicates a more ordered, crystalline material.

FIG. 10 is an image showing carbon product 140 obtained from pyrolysis according to the invention. Although a large proportion of carbon product 140 is graphitic, some amorphous carbon is still formed during pyrolysis and clearly present in carbon product 140.

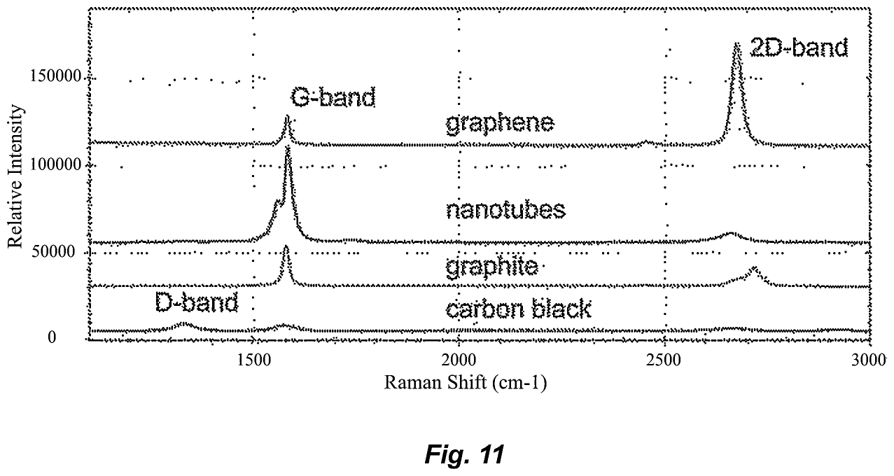

FIG. 11 illustrates the Raman spectra of graphene, carbon nanotubes, graphite and carbon black. These spectra have been manually offset in FIG. 11 for clarity. A person skilled in the art will realize that these spectra can be deployed in characterizing the content of carbon product 140.

Now, there are several parameters affecting crystallization and graphite yield in carbon product 140. These parameters include the pyrolyzation temperature, residence time of hydrocarbon feedstock 102 in supersaturated molten mixture 116 and bubble size. Longer residence time is also preferable for increased graphite yield. Accordingly, it is advantageous to increase the height or depth of supersaturated molten mixture 116 to ensure longer residence time. This ensures that gas bubbles with hydrocarbon feedstock 102 reside in supersaturated molten mixture 116 for longer before reaching its surface as they travel upwards due to buoyancy. In a preferred embodiment tuned for high graphite yield the height or depth of supersaturated molten mixture 116 is over 15 cm.

The parameter of bubble size affects the rate at which carbon is solubilized in supersaturated molten mixture 116. Smaller bubble size increases the rate at which carbon is solubilized and can increase the yield of graphite in carbon product 140. Thus, in one embodiment a sparger plate with a plurality of orifices is used in injection apparatus 118 to act like a sieve and distribute supply flow 114 of hydrocarbon feedstock 102 being injected into supersaturated molten mixture 116. In another embodiment that reduces bubble size hydrocarbon feedstock 102 is injected into supersaturated molten mixture 116 at high velocity using flow regulator 112. Injection at high velocity enables the formation of smaller bubbles through shear force.

Furthermore, the invention extends to performing the above-described process for obtaining carbon product 140 through thermochemical decomposition of hydrocarbon feedstock 102. Of particular interest is carbon product 140 that is highly graphitic according to the criteria described above.

It will be evident to one skilled in the art that the above parameters affecting crystalline carbon yield in carbon product 140 will also affect other parameters of carbon product 140. These parameters include particle size, density, surface area, morphology and crystallinity. The above parameters can be tuned to adjust carbon product 140 for desirable final parameters. Indeed, it will be evident to a person skilled in the art that the present invention admits of still other embodiments and variants. Therefore, its scope should be judged by the claims and their legal equivalents.

1. A decomposition reactor for a thermochemical decomposition of a hydrocarbon feedstock, said decomposition reactor comprising:
a) a thermochemical decomposition reactor for holding a supersaturated molten mixture comprising primarily a metal and carbon;
b) a heater for heating said supersaturated molten mixture and for maintaining supersaturation;
c) a means for injecting a supply flow of said hydrocarbon feedstock into said supersaturated molten mixture held in said thermochemical decomposition reactor such that said hydrocarbon feedstock passes through said supersaturated molten mixture to pyrolyze said hydrocarbon feedstock into pyrolysis products comprising primarily hydrogen and a carbon product;
d) a hydrogen extraction means for extracting hydrogen from said supersaturated molten mixture; and
e) a carbon separation means for separating said carbon product.

2. The decomposition reactor of claim 1, wherein said metal is selected from the group consisting of Mn, Fe, Co, Ni or an alloy comprising more than 50% of metal from the group.

3. The decomposition reactor of claim 1, wherein said hydrocarbon feedstock substantially comprises methane or natural gas and said carbon product comprises a solid carbon product.

4. The decomposition reactor of claim 1, wherein said carbon product comprises a solid carbon product with a fraction of a crystalline phase of carbon defined as graphite, graphene, nanotubes, diamond and fullerenes.

5. The decomposition reactor of claim 3, wherein said carbon product comprises a solid carbon product that is highly graphitic.

6. The decomposition reactor of claim 1, wherein said heater maintains said supersaturated molten mixture at a temperature between 1,100° C. and 2,000° C.

7. The decomposition reactor of claim 1, wherein said pyrolysis products comprise pyrolysis gases and said carbon separation means is configured to fluidize said carbon product out of said decomposition reactor by said pyrolysis gases.

8. The decomposition reactor of claim 1, wherein the height of said supersaturated molten mixture into which said supply flow of said hydrocarbon feedstock is injected is greater than 2 cm.

9. The decomposition reactor of claim 1, wherein said heater is selected from the group consisting of electrical resistive heaters, induction heaters, microwave heaters, electric arc heaters, natural gas burners, hydrogen burners, hydrocarbon burners, plasma heaters and a thermal energy storage medium.

10. A process for thermochemical decomposition of a hydrocarbon feedstock, said process comprising:
a) providing a thermochemical decomposition reactor for holding a molten metal bath comprising primarily a metal and carbon;
b) providing a heater for heating said molten metal bath to obtain a supersaturated molten mixture and maintaining supersaturation at a temperature between 1,100° C. and 2,000° C.;
c) injecting a supply flow of said hydrocarbon feedstock into said supersaturated molten mixture held in said thermochemical decomposition reactor such that said hydrocarbon feedstock passes through said supersaturated molten mixture to pyrolyze said hydrocarbon feedstock into pyrolysis products comprising primarily hydrogen and a carbon product, and wherein said pyrolysis products comprise pyrolysis gases;
d) extracting hydrogen from said supersaturated molten mixture; and
e) separating said carbon product.

11. The process according to claim 10, wherein said metal is selected from the group consisting primarily (>50%) of Mn, Fe, Co and Ni or an alloy comprising more than 50% of metal from the group.

12. The process according to claim 10, wherein said hydrocarbon feedstock substantially comprises methane or natural gas and said carbon product comprises a solid carbon product.

13. The process according to claim 10, wherein said carbon product comprises a solid carbon product with a fraction of a crystalline phase of carbon defined as graphite, graphene, nanotubes, diamond and fullerenes.

14. The process according to claim 10, wherein said carbon product comprises a solid carbon product that is highly graphitic and is used as an electrode for batteries, electric arc furnaces or supercapacitors.

15. The process according to claim 10, wherein said step of separating said carbon product comprises partial or full fluidization out of said thermochemical decomposition reactor by said pyrolysis gases.

16. The process according to claim 10, wherein the height of said supersaturated molten mixture into which said supply flow of said hydrocarbon feedstock is injected is greater than 2 cm.

17. The process according to claim 10, wherein said heater is selected from the group of electrical resistive heaters, induction heaters, microwave heaters, electric arc heaters, natural gas burners, hydrogen burners, hydrocarbon burners, plasma heaters and a thermal energy storage medium.

18. The process according to claim 10, wherein the height of said supersaturated into which said supply flow of said hydrocarbon feedstock is injected is greater than 10 cm.

19. The process according to claim 10, wherein said step of injecting said hydrocarbon feedstock is performed through a plurality of orifices.

20. A carbon product obtained in a process of thermochemical decomposition of a hydrocarbon feedstock, said process comprising:
a) providing a thermochemical decomposition reactor for holding a molten metal bath comprising primarily a metal and carbon;
b) providing a heater for heating said molten metal bath to obtain a supersaturated molten mixture and maintaining supersaturation at a temperature between 1,100° C. and 2,000° C.;
c) injecting a supply flow of said hydrocarbon feedstock into said supersaturated molten mixture held in said thermochemical decomposition reactor such that said hydrocarbon feedstock passes through said supersaturated molten mixture to pyrolyze said hydrocarbon feedstock into pyrolysis products comprising primarily hydrogen and said carbon product, and wherein said pyrolysis products comprise pyrolysis gases;
d) extracting said pyrolysis gases from said thermochemical decomposition reactor; and
e) separating said carbon product.

21. The carbon product obtained according to claim 20, wherein said metal is selected from the group consisting primarily (>50%) of Mn, Fe, Co and Ni or an alloy comprising more than 50% of metal from the group.

22. The carbon product obtained according to claim 20, wherein said hydrocarbon feedstock substantially comprises methane or natural gas and said carbon product comprises a solid carbon product.

23. The carbon product obtained according to claim 20, wherein said carbon product comprises a solid carbon product with a fraction of a crystalline phase of carbon defined as graphite, graphene, nanotubes, diamond and fullerenes.

24. The carbon product obtained according to claim 20, wherein said carbon product comprises a solid carbon product that is highly graphitic and is used as an electrode for batteries, electric arc furnaces or supercapacitors.

25. The carbon product obtained according to claim 20, wherein said step of separating said carbon product comprises partial or full fluidization out of said thermochemical decomposition reactor by said pyrolysis gases.
